(19) United States
(12) Patent Application Publication
(10) Pub. No.: US 2018/0235826 A1
(43) Pub. Date: Aug. 23, 2018

(54) Traction therapy systems and related methods

(71) Applicant: Jason Orion Jaeger, Las Vegas, NV (US)

(72) Inventor: Jason Orion Jaeger, Las Vegas, NV (US)

(21) Appl. No.: 15/732,413

(22) Filed: Nov. 8, 2017

Related U.S. Application Data
(60) Provisional application No. 62/498,084, filed on Dec. 14, 2016.
(60) Provisional application No. 62/497,215, filed on Nov. 9, 2016.

(51) Int. Cl. A61H 1/00

(52) U.S. Cl. CPC A61H 1/008; A61H 2201/0149; A61G 13/009; A61H 2201/0192; A61H 2205/081

(57) ABSTRACT

The present invention is generally directed to systems, devices and methods in the area of chiropractic therapy. In one embodiment, the present invention provides a traction therapy system. The system includes: a bench, including an adjustable back rest that is adjustable to every angle from 90 degrees horizontal to 90 degrees vertical, wherein the bench is in contact with a frame, wherein the frame includes one or more mechanisms by which the bench is contacted with the frame and one adjustable angle unilateral traction arm that adjusts from −55 degrees to +55 degrees rotating around the x-axis, and wherein the one adjustable angle unilateral traction arm is connected to a winch mounting arm, and wherein a winch is connected to the winch mounting arm, and wherein the winch is operably connected to a crossbar, and wherein a harness that is capable of fitting underneath a person is connected to the crossbar.

### FIELD OF THE INVENTION

The present invention is generally directed to systems, devices and methods in the area of chiropractic therapy.

### BACKGROUND

There have been several efforts directed to the development of chiropractic devices. U.S. Pat. No. 9,345,633 issued May 24, 2016 to Activator Methods International Ltd. and entitled “Chiropractic Adjustor System and Method” allegedly reports the following: “A portable battery power operated chiropractic adjusting instrument, manipulator or thruster for applying a selectable adjustment energy impulse to a patient through a plunger having a resilient or cushioned head with the energy impulse applied to the plunger being supplied by a solenoid. The adjusting instrument can have annunciators or indicators for preload, readiness to operate, level of energy impulse and the like. The power source can be an internal rechargeable battery or removable rechargeable battery pack.” Abstract.

U.S. Pat. No. 9,009,894 issued Apr. 21, 2015 to Posture Correction Tools, LLC and entitled “Chiropractic Posture Correction Tool” allegedly discusses the following: “The claimed invention provides an improved posture correction tool in the form of a table to be used by chiropractic practitioners to treat mechanical disorders of the spine and musculoskeletal system. The improved posture correction tool provides a plurality of pads to support the various major areas of the body and has built in drop capability and adjustment capability for the pelvic pad, the lumbar pad, the thoracic pad and the head and cervical area. The claimed invention also has a novel cervical support.” Abstract.

U.S. Pat. No. 8,882,802 issued Nov. 11, 2014 to Yi-Chin Kao and entitled “Chiropractic Machine” allegedly discloses the following: “A chiropractic machine is disclosed which uses separate supporting members for the various body parts of a patient. These separate supporting members are mounted on a flexible structure that allows them to be rotated and elongated in relation to each other. This allows greater flexibility and range of motion, thus facilitating chiropractic treatment.” Abstract.

U.S. Pat. No. 8,672,971 issued Mar. 18, 2014 to Bernwart Kellner and entitled “Chiropractic Table Apparatus and Method of Use” allegedly describes the following: “A chiropractic table has a base, a table support member connected to the base and extending upward from the base, an axial-lateral-tilt mechanism laterally connected to table support member, a cephalad section connected transversely to and being supported by the table support member above the base, a head section connected to and extending longitudinally from a first cephalad section end of the cephalad section, and a caudal section interconnected with the axial-lateral-tilt mechanism and the table support member and being positioned longitudinally adjacent a second cephalad section end of the cephalad section where the axial-lateral-tilt mechanism has an axial pivot mechanism configured to axially swing the caudal section along a predefined arc, the arc coinciding with a predefined radial distance from a pivot axis that is parallel to a longitudinal axis of the chiropractic table and located a predefined distance above a top surface of the chiropractic table.” Abstract

Despite such efforts, there is still a need in the art for novel traction therapy systems and related methods.

### SUMMARY OF THE INVENTION

In one embodiment, the present invention provides a traction therapy system. The system includes: a bench, including an adjustable back rest that is adjustable to every angle from 90 degrees horizontal to 90 degrees vertical, wherein the bench is in contact with a frame, wherein the frame includes one or more mechanisms by which the bench is contacted with the frame and one adjustable angle unilateral traction arm that adjusts from −55 degrees to +55 degrees rotating around the x-axis, and wherein the one adjustable angle unilateral traction arm is connected to a winch mounting arm, and wherein a winch is connected to the winch mounting arm, and wherein the winch is operably connected to a crossbar, and wherein a harness that is capable of fitting underneath a person is connected to the crossbar.

In another embodiment, the present invention provides a method of lumbar extension traction which increases lordosis in a chronic low back pain subject with decreased lordosis, wherein the method includes the following steps: providing a traction therapy system, wherein the system includes a bench, including an adjustable back rest that is adjustable to every angle from 90 degrees horizontal to 90 degrees vertical, wherein the bench is in contact with a frame, wherein the frame includes one or more mechanisms by which the bench is contacted with the frame and one adjustable angle unilateral traction arm that adjusts from −55 degrees to +55 degrees rotating around the x-axis, and wherein the one adjustable angle unilateral traction arm is connected to a winch mounting arm, and wherein a winch is connected to the winch mounting arm, and wherein the winch is operably connected to a crossbar, and wherein a harness that is capable of fitting underneath a person is connected to the crossbar, to a patient; allowing the patient to sit on the bench such that the harness can be fitted around a portion of the patient's lumbar region; applying traction to the patient's lumbar region using the harness such that, over time, lordosis in the chronic low back pain subject is increased.

### BRIEF DESCRIPTION OF THE DRAWINGS

FIG. 1 shows a traction system according to the present invention.

FIG. 2 shows various views of a traction system according to the present invention.

FIG. 3 shows adjustable eyelets used in a traction system according to the present invention.

FIG. 4 shows a bench with adjustable back rest and adjustable angle unilateral traction arm used in a traction system according to the present invention.

FIG. 5 shows another view of a bench with an adjustable back rest used in a traction system according to the present invention.

FIG. 6 shows another view of a bench with an adjustable back rest used in a traction system according to the present invention.

FIG. 7 shows an angled plate with bolts used to connect the vertical unilateral traction arm to the winch mounting arm in a traction system according to the present invention.

FIG. 8 shows various portions of a traction system according to the present invention, including an adjustable metal stand with vertical unilateral arm and a winch.

FIG. 9 shows a portion of a traction system according to the present invention, including an adjustable chiropractic bench connected to a frame and a harness attached to a cross bar, where the cross bar is operably connected to the winch.

FIG. 10 shows an adjustable chiropractic bench attached to a metal frame, along with an adjustable vertical unilateral arm, in a traction system according to the present invention.

FIG. 11 shows a traction system according to the present invention, including an adjustable bench, a frame including an adjustable vertical unilateral arm attached to a winch mounting arm, where the attached winch is operably connected to a cross bar that controls a harness.

FIG. 12 shows two views of a person utilizing a traction system according to the present invention. As shown, the person is reclining at an angle (e.g., 45 degree angle), with moveable supports underneath is calves. Lumbar traction is being applied by a harness attached to a crossbar and controlled by a winch. The winch is attached to the winch mounting arm, which is in turn connected to the adjustable vertical unilateral arm.

FIG. 13 shows a view of a person utilizing a traction system according to the present invention. As shown, the person is in a supine position, and lumbar traction is being applied by a harness attached to a crossbar and controlled by a winch. The winch is attached to the winch mounting arm, which is in turn connected to the adjustable vertical unilateral arm.

FIG. 14 shows another view of a person utilizing a traction system according to the present invention, where the person is supine and lumbar traction is being applied by a harness attached to a crossbar and controlled by a winch.

FIG. 15 shows another view of a person utilizing a traction system according to the present invention, where the person is supine and lumbar traction is being applied by a harness attached to a crossbar and controlled by a winch.

### DETAILED DESCRIPTION OF THE INVENTION

Various traction devices have been discussed in the literature. For instance, one is a rectangular shaped wood or metal object that goes over the top of a patient on a supine recumbent bench that is attached to a winch and rope. This typically applies a force into the lumbar spine over a period of time of greater than 10 minutes and up to 20 minutes, 3 to 4 times per week, for 9 to 12 weeks (approximating 30 to 36 sessions of treatment). A follow-up x-ray is usually performed 1 to 2 days after the last treatment session to assess any measurable changes and lumbar lordosis. The device, however, has a two vertical arms going up to a horizontal bar where the winch is mounted.

The two vertical arms of the device discussed above create a serious limitation in the application of the device. A patient with potential back symptoms and/or spinal disorder must sit on the end of a bench placed between the two vertical arms and shimmy back into position under the device. Certain patients cannot position themselves within the device.

In addition, after the patient completes the traction therapy, his/her spine has been under a load for a time between 10 and 20 minutes. It has proven even more difficult for the patient to get out of the device and go from the recumbent to the standing position.

Similarly conservative treatments for scoliosis have historically been limited to pain and symptom management interventions including exercise and spinal manipulation or adjustment. However these interventions have not been shown to reduce the angles of measurements of scoliosis, or correct the condition. The only documented healthcare intervention historically to correct scoliosis has been invasive spinal surgeries that pose a potential for injury disability or morbidity.

The present invention is a new and novel device that allows easy side access entry to the machine as well as an improved and more comfortable method to sit, lie supine, lie recumbent and/or side lie in a horizontal or 45° degree position, or any angle between 45° and 0° horizontal. There is further an ability to angle your legs and feet up or down relative to the pelvis or to angle the head up or down, relative to the thorax.

The present invention has a novel unilateral arm. The one vertical post will allow patients with pain symptomology or disability to use this device where previously they could not. Alternatively, if they did, they would have serious and significant hardship in getting into or out of the device.

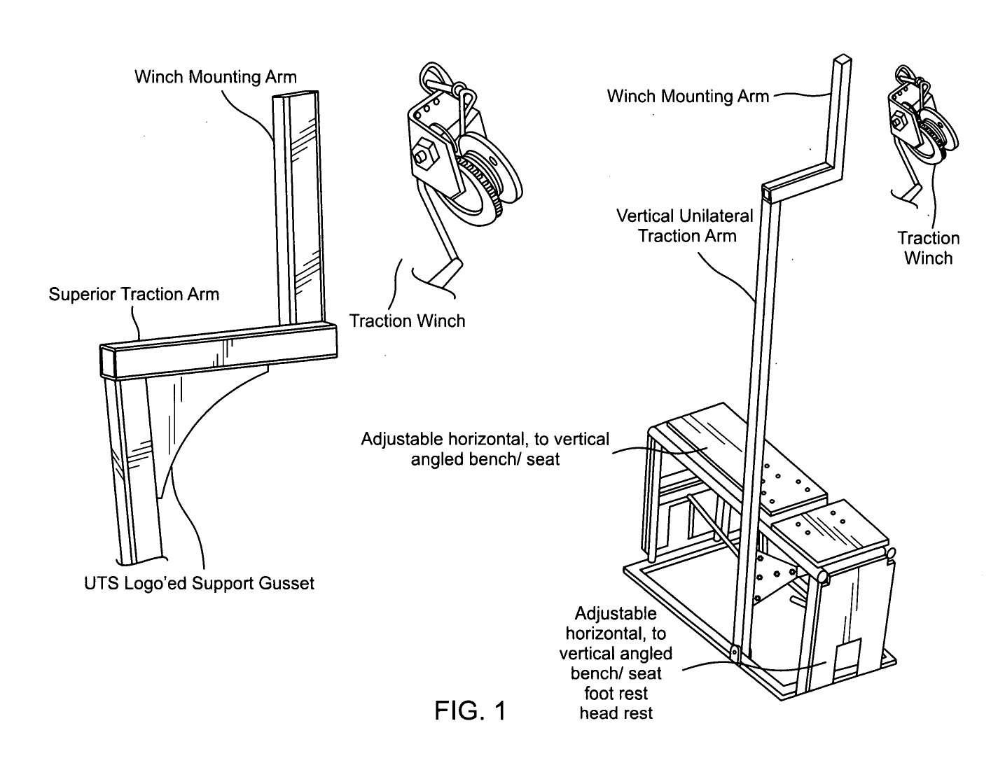

Systems, devices and methods are discussed in terms of the figures below. FIG. 1 shows a traction system according to the present invention. The image on the left shows a support gusset including a superior traction arm, a winch mounting arm and a traction winch. The image on the right shows a traction system including the support gusset. An adjustable horizontal, to vertical angled bench/seat, foot rest and head rest in contact with a device frame is illustrated. The winch mounting arm to which the traction winch is attached, as well as the vertical unilateral traction arm, is displayed.

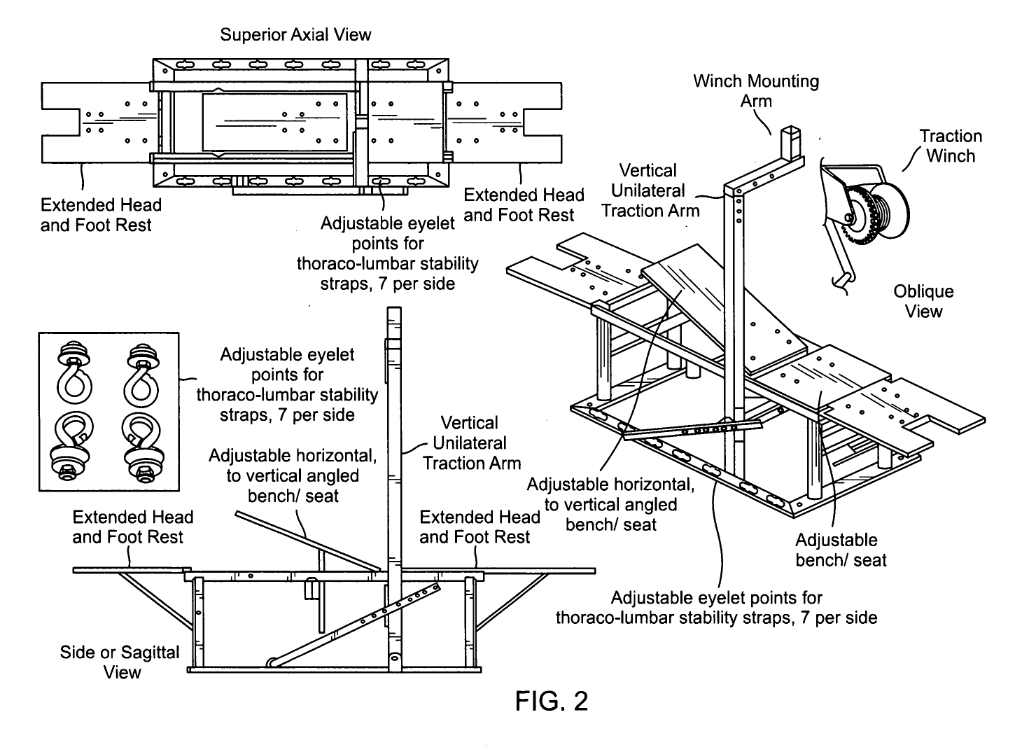

FIG. 2 shows various views of a traction system according to the present invention. A superior axial view of the system, including an extended head and foot rest and adjustable eyelet points for thoraco-lumbar stability straps (7 per side), is shown, as well as a side or sagittal view of the system. The side or sagittal view of the system comprises an adjustable horizontal, to vertical angled bench/seat with an extended head and foot rest, along with a vertical unilateral traction arm. An oblique view of the system is also shown, which displays the vertical unilateral traction arm, which is connected to the winch mounting arm and traction winch. The adjustable bench/seat is illustrated, along with adjustable eyelet points for thoraco-lumbar stability straps (7 per side).

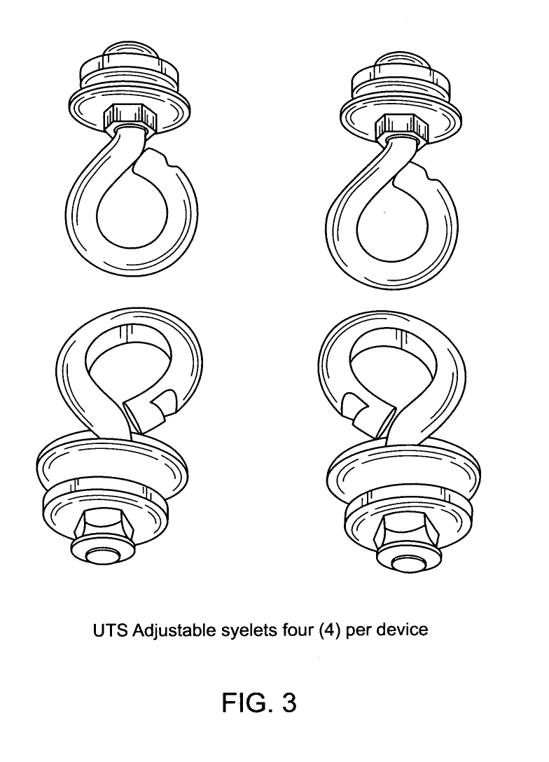

FIG. 3 shows adjustable eyelets used in a traction system according to the present invention.

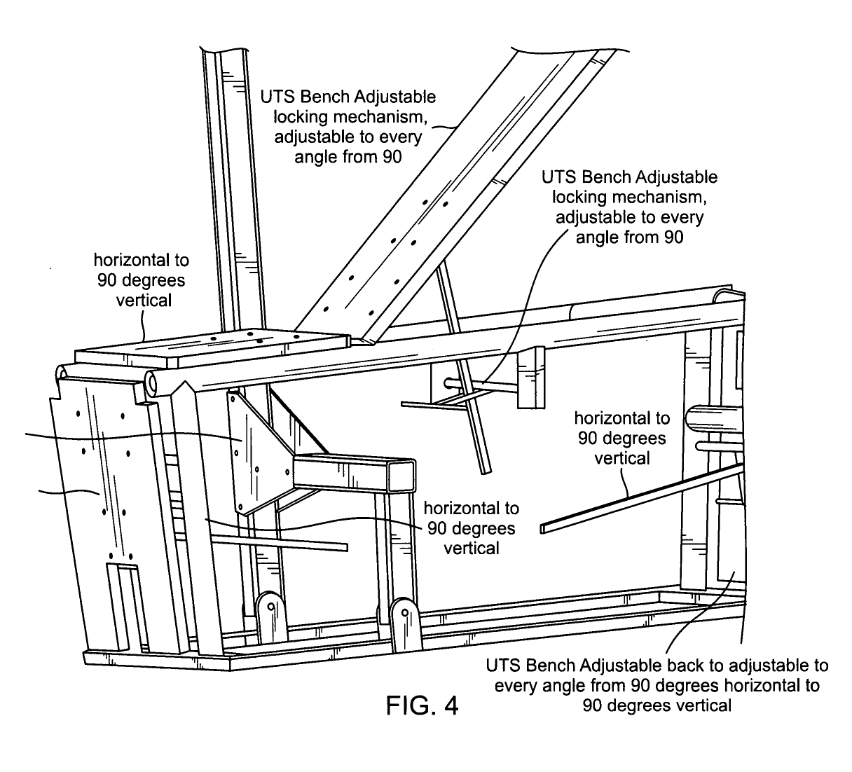

FIG. 4 shows a bench with adjustable back rest and adjustable angle unilateral traction arm used in a traction system according to the present invention. The adjustable angle unilateral traction arm, as shown, adjusts from −55 degrees to +55 degrees rotating around the x-axis. The illustrated UTS bench adjustable back rest is adjustable to every angle from 90 degrees horizontal to 90 degrees vertical. The UTS bench adjustable back rest is adjustable to every angle from 90 degrees horizontal to 90 degrees vertical. As displayed, the UTS bench adjustable locking mechanism is adjustable to every angle from 90 degrees horizontal to 90 degrees vertical.

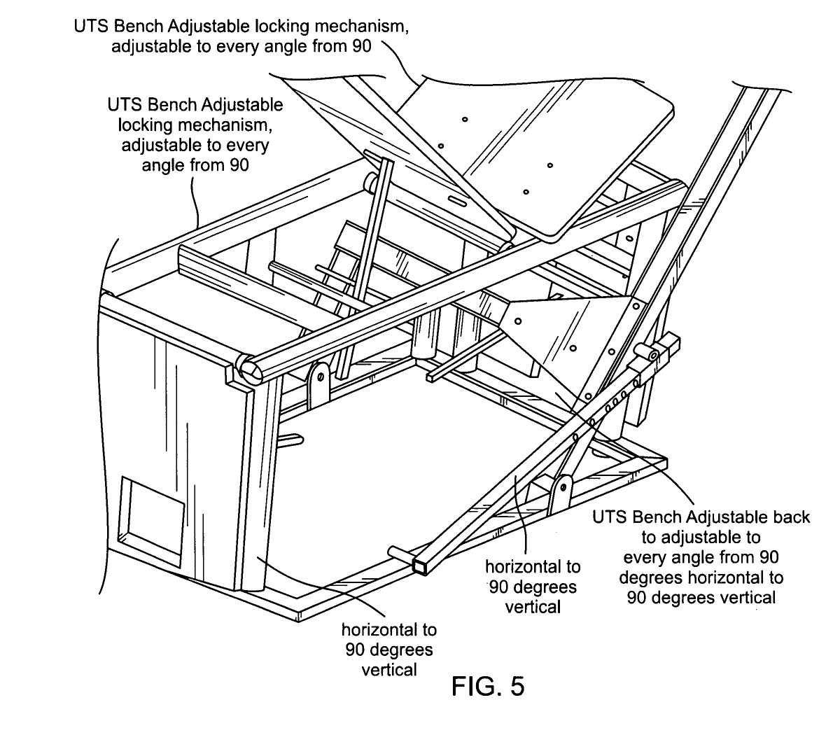

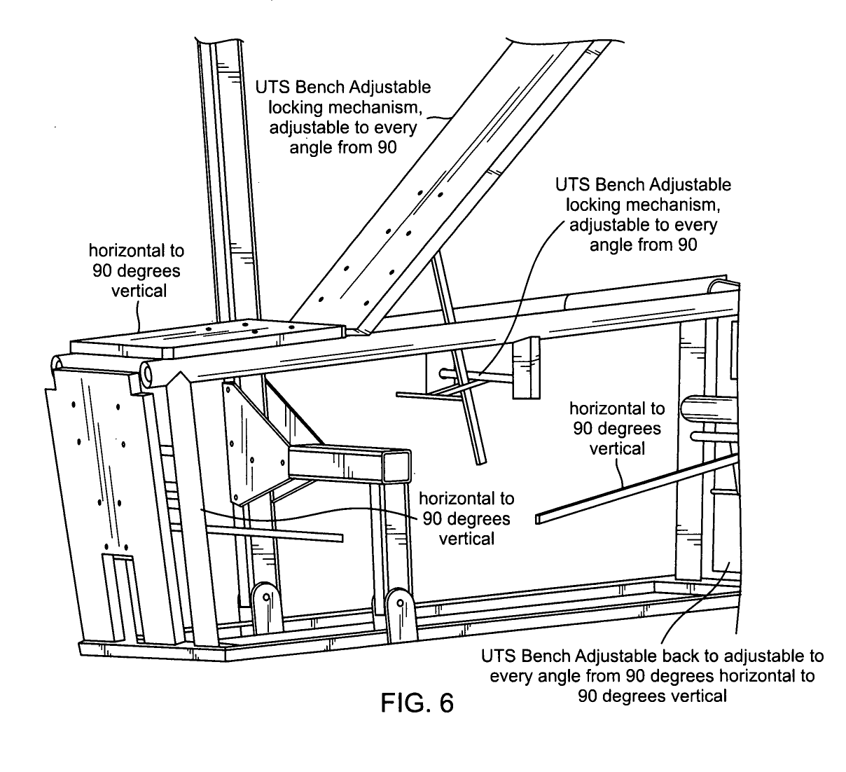

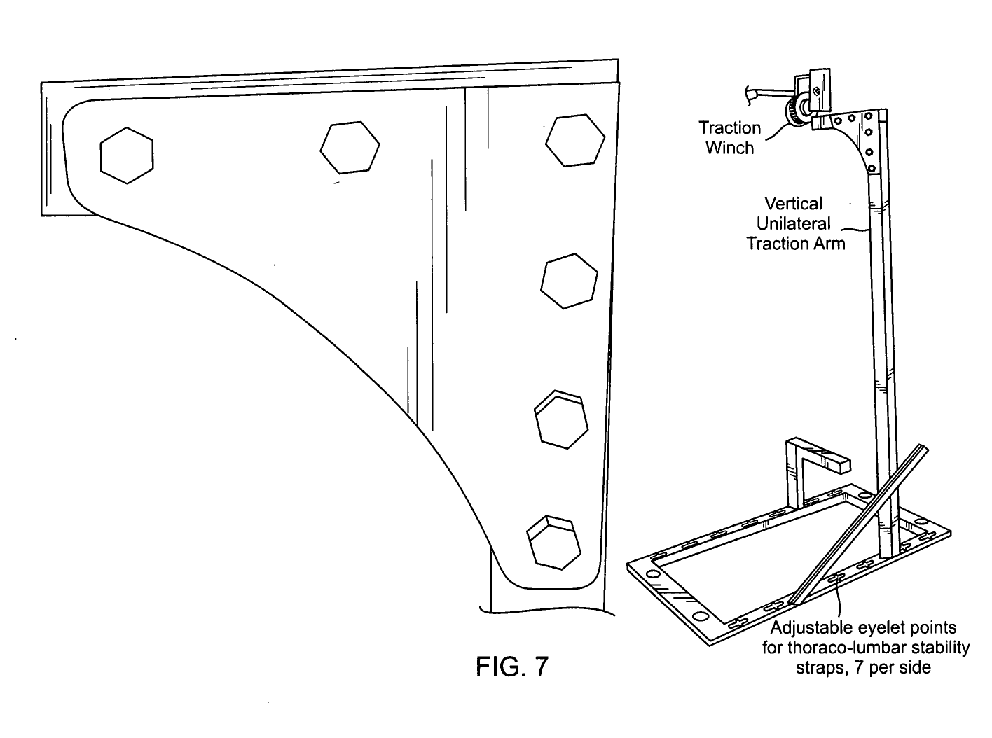

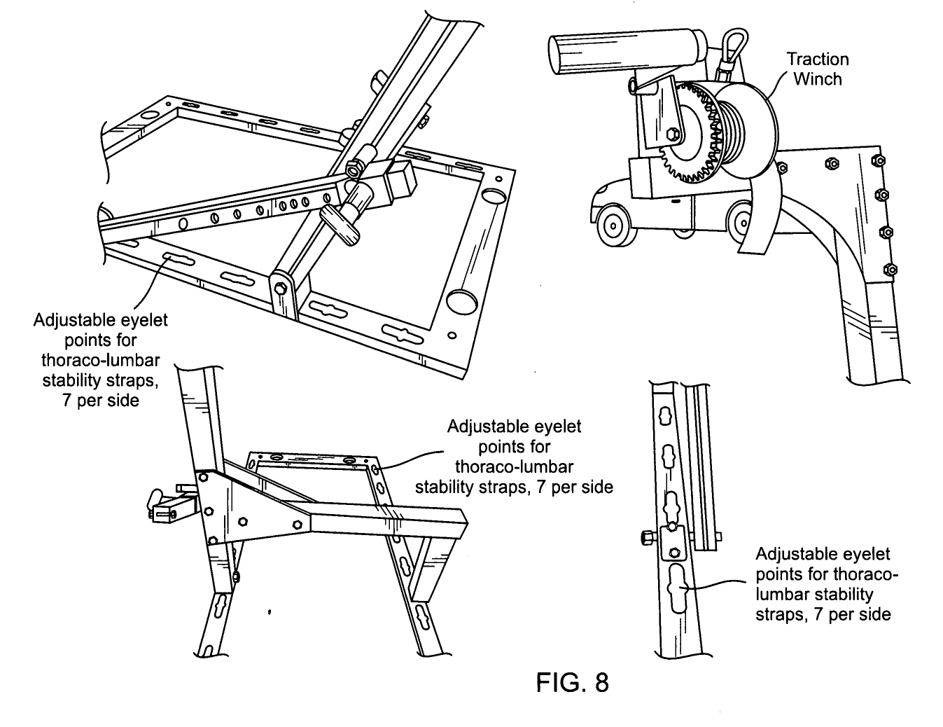

FIG. 5 shows another view of a bench with an adjustable back rest used in a traction system according to the present invention. FIG. 6 shows still another view of a bench with an adjustable back rest used in a traction system according to the present invention. FIG. 7 shows an angled plate with bolts used to connect the vertical unilateral traction arm to the winch mounting arm in a traction system according to the present invention. FIG. 8 shows various portions of a traction system according to the present invention, including an adjustable metal stand with vertical unilateral arm and a winch.

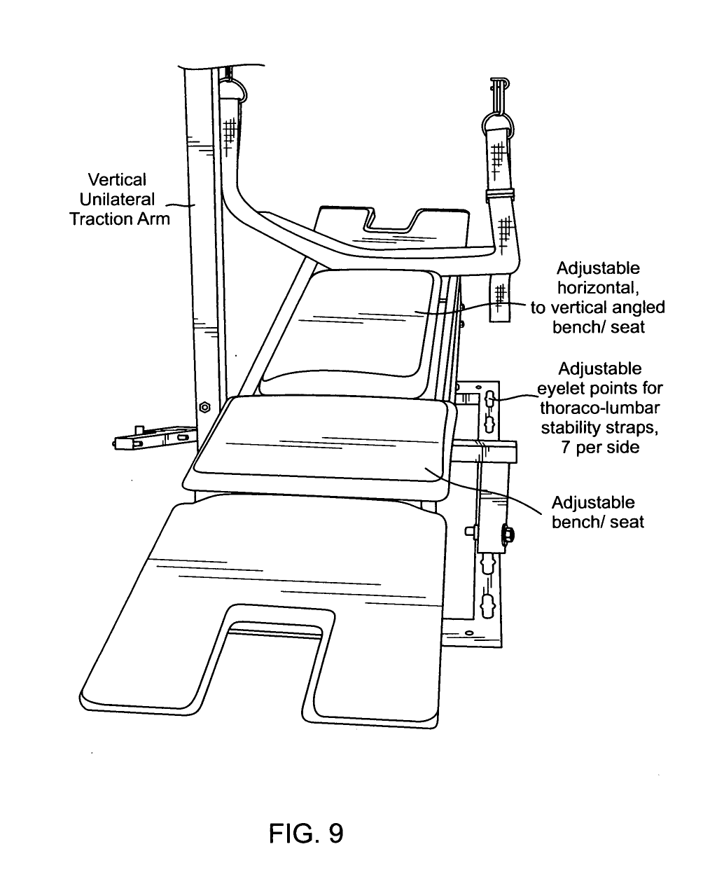

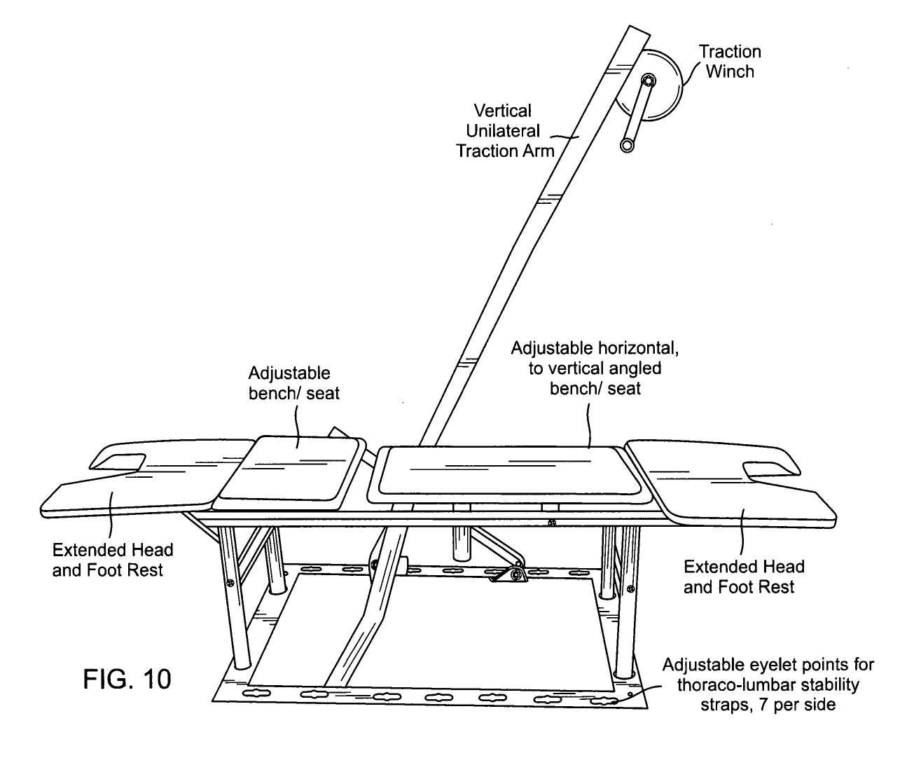

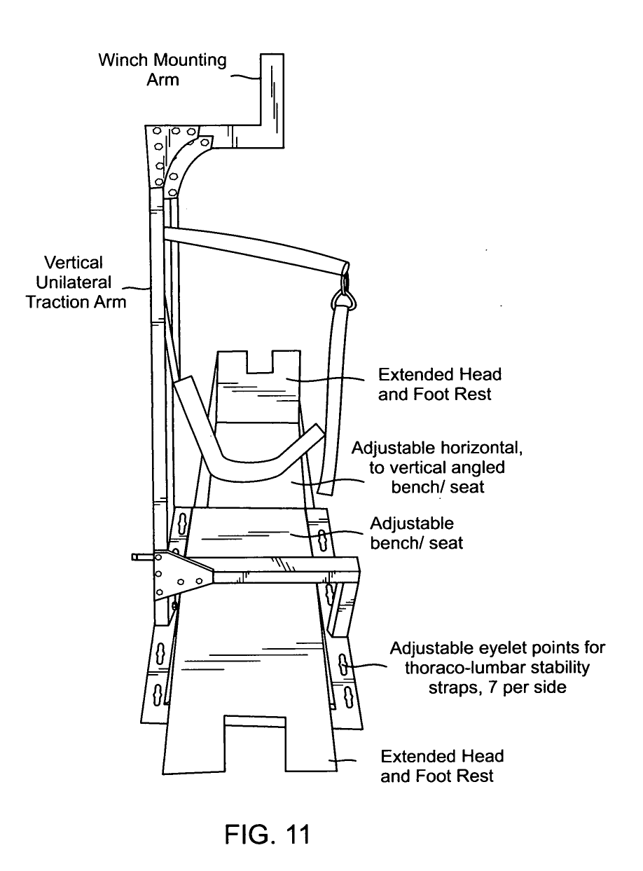

FIG. 9 shows a portion of a traction system according to the present invention, including an adjustable chiropractic bench connected to a frame and a harness attached to a cross bar, where the cross bar is operably connected to the winch. FIG. 10 shows an adjustable chiropractic bench attached to a metal frame, along with an adjustable vertical unilateral arm, in a traction system according to the present invention. FIG. 11 shows a traction system according to the present invention, including an adjustable bench, a frame including an adjustable vertical unilateral arm attached to a winch mounting arm, where the attached winch is operably connected to a cross bar that controls a harness.

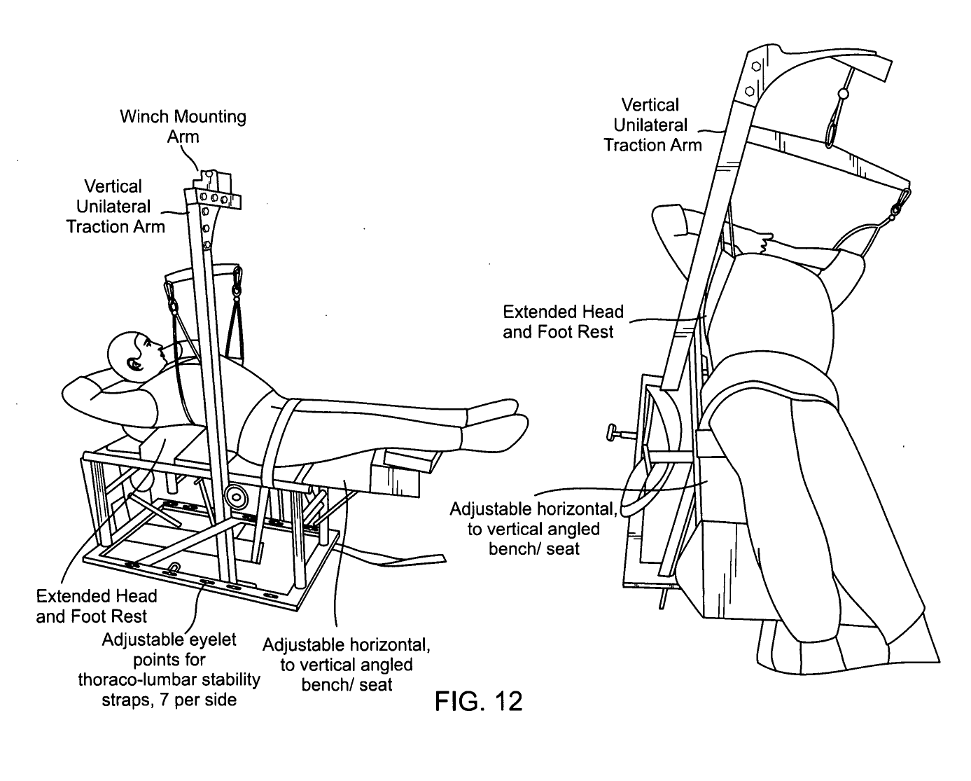

FIG. 12 shows two views of a person utilizing a traction system according to the present invention. As shown, the person is reclining at an angle (e.g., 45 degree angle), with moveable supports underneath is calves. Lumbar traction is being applied by a harness attached to a crossbar and controlled by a winch. The winch is attached to the winch mounting arm, which is in turn connected to the adjustable vertical unilateral arm.

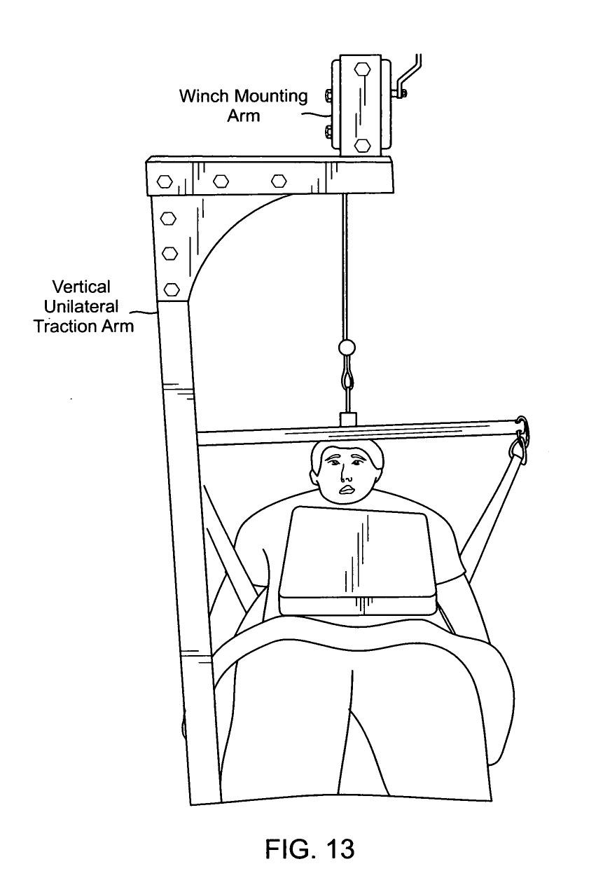

FIG. 13 shows a view of a person utilizing a traction system according to the present invention. As shown, the person is in a supine position, and lumbar traction is being applied by a harness attached to a crossbar and controlled by a winch. The winch is attached to the winch mounting arm, which is in turn connected to the adjustable vertical unilateral arm.

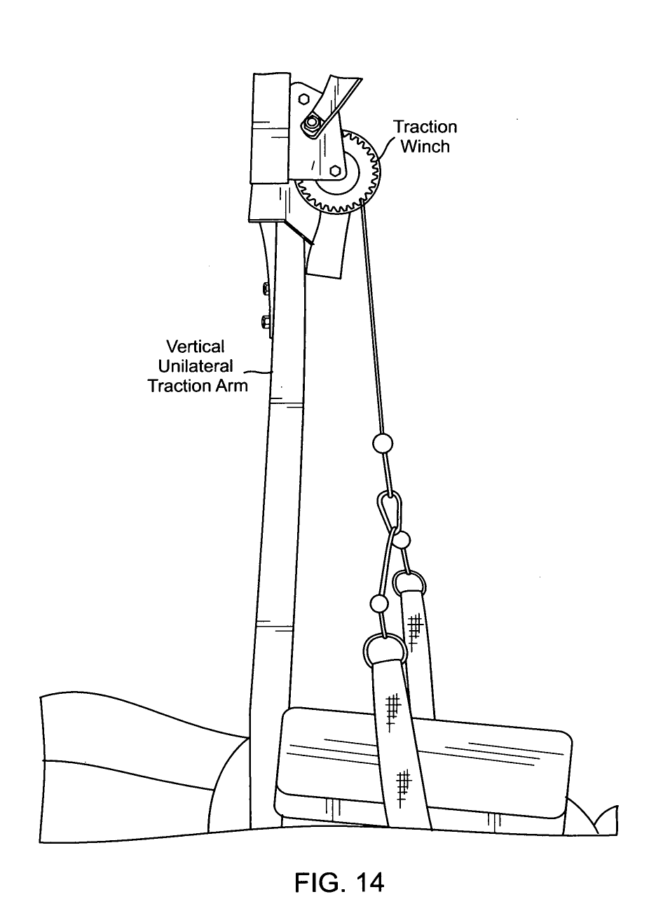

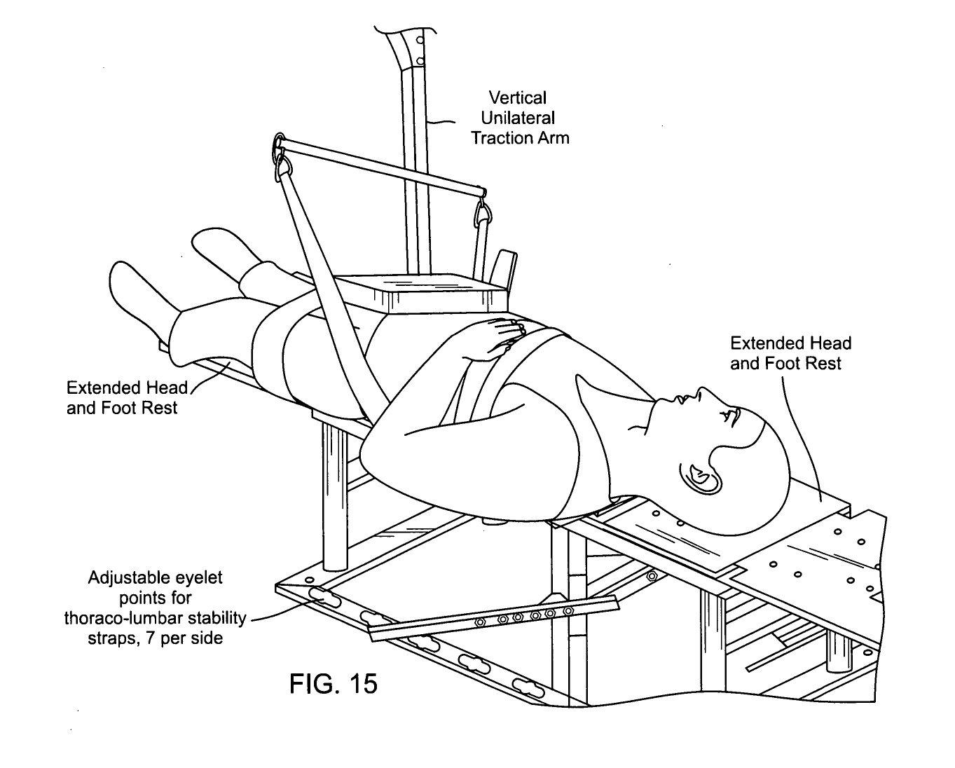

FIG. 14 shows another view of a person utilizing a traction system according to the present invention, where the person is supine and lumbar traction is being applied by a harness attached to a crossbar and controlled by a winch. FIG. 15 shows another view of a person utilizing a traction system according to the present invention, where the person is supine and lumbar traction is being applied by a harness attached to a crossbar and controlled by a winch.

In one embodiment, the traction therapy system according to the present invention, includes, without limitation, the following: a bench, including an adjustable back rest that is adjustable to every angle from 90 degrees horizontal to 90 degrees vertical, wherein the bench is in contact with a frame, wherein the frame includes one or more mechanisms by which the bench is contacted with the frame and one adjustable angle unilateral traction arm that adjusts from −55 degrees to +55 degrees rotating around the x-axis, and wherein the one adjustable angle unilateral traction arm is connected to a winch mounting arm, and wherein a winch is connected to the winch mounting arm, and wherein the winch is operably connected to a crossbar, and wherein a harness that is capable of fitting underneath a person is connected to the crossbar.

Various methods can be used in operating the traction therapy systems according to the present invention. Prior devices, among other issues, have used two vertical arms rather than the one used in the present invention. The two vertical arms create a serious limitation in the application of the subject device. A patient with potential back symptoms and/or a spinal disorder must sit on the end of a bench placed between the two vertical arms and shimmy into positions for the device. Many patients with such disorders, however, cannot position themselves in that way. It may even be worse after a patient completes traction therapy, since going from a recumbent position to a standing position following traction, especially for a patient with the aforementioned disorders, is very difficult.

In one embodiment, the present invention provides a method of lumbar extension traction which increases lordosis in a chronic low back pain subject with decreased lordosis, wherein the method includes the following steps: 1) providing a traction therapy system, wherein the system includes a bench, including an adjustable back rest that is adjustable to every angle from 90 degrees horizontal to 90 degrees vertical, wherein the bench is in contact with a frame, wherein the frame includes one or more mechanisms by which the bench is contacted with the frame and one adjustable angle unilateral traction arm that adjusts from −55 degrees to +55 degrees rotating around the x-axis, and wherein the one adjustable angle unilateral traction arm is connected to a winch mounting arm, and wherein a winch is connected to the winch mounting arm, and wherein the winch is operably connected to a crossbar, and wherein a harness that is capable of fitting underneath a person is connected to the crossbar, to a patient; 2) allowing the patient to sit on the bench such that the harness can be fitted around a portion of the patient's lumbar region; 3) applying traction to the patient's lumbar region using the harness such that, over time, lordosis in the chronic low back pain subject is increased.

A nonlimiting example of a treatment regimen using the systems and methods of the present invention is as follows: traction performed three or four times per week for eight, nine, ten, eleven or twelve weeks; traction duration in week one started at one, two or three minutes and was increased over the eight to twelve week period to 10 minutes, 11 minutes, 12 minutes, 13 minutes, 14 minutes, 15 minutes, 16 minutes, 17 minutes, 18 minutes, 19 minutes or 20 minutes.

The systems and methods of the present invention can have measurable, beneficial effects on patients (e.g., those with decreased lordosis). For example, in certain cases, the average pain on a visual analog scale (VAS) for a group of ten, twenty, thirty, forty or fifty patients is decreased by a value of at least one, two, three, four or five on a ten point scale (e.g., from 10 to 8), and the decrease is statistically significant. In other cases, Cobb angles, at the inferior endplate of T12 and superior sacral base, for a group of ten, twenty, thirty, forty or fifty patients is increased by a value of at least one degree, two degrees, three degrees, four degrees, five degrees, six degrees, seven degrees, eight degrees or nine degrees, and the increase is statistically significant.

1. A traction therapy system, wherein the system comprises: a bench, including an adjustable back rest that is adjustable to every angle from 90 degrees horizontal to 90 degrees vertical, wherein the bench is in contact with a frame, wherein the frame includes one or more mechanisms by which the bench is contacted with the frame and one adjustable angle unilateral traction arm that adjusts from −55 degrees to +55 degrees rotating around the x-axis, and wherein the one adjustable angle unilateral traction arm is connected to a winch mounting arm, and wherein a winch is connected to the winch mounting arm, and wherein the winch is operably connected to a crossbar, and wherein a harness that is capable of fitting underneath a person is connected to the crossbar.

2. A method of lumbar extension traction which increases lordosis in a chronic low back pain subject with decreased lordosis, wherein the method comprises the following steps:
providing a traction therapy system, wherein the system includes a bench, including an adjustable back rest that is adjustable to every angle from 90 degrees horizontal to 90 degrees vertical, wherein the bench is in contact with a frame, wherein the frame includes one or more mechanisms by which the bench is contacted with the frame and one adjustable angle unilateral traction arm that adjusts from −55 degrees to +55 degrees rotating around the x-axis, and wherein the one adjustable angle unilateral traction arm is connected to a winch mounting arm, and wherein a winch is connected to the winch mounting arm, and wherein the winch is operably connected to a crossbar, and wherein a harness that is capable of fitting underneath a person is connected to the crossbar, to a patient;
allowing the patient to sit on the bench such that the harness can be fitted around a portion of the patient's lumbar region;
applying traction to the patient's lumbar region using the harness such that, over time, lordosis in the chronic low back pain subject is increased.
